(19) United States
(12) Patent Application Publication
(10) Pub. No.: US 2013/0231594 A1
(43) Pub. Date: Sep. 5, 2013

(54) HEATED ROLLER APPARATUS

(71) Applicant: Alexander J. Bennett, Sammamish, WA (US)

(72) Inventor: Alexander J. Bennett, Sammamish, WA (US)

(21) Appl. No.: 13/861,783

(22) Filed: Apr. 12, 2013

Related U.S. Application Data
(60) Provisional application No. 61/752,807, filed on Jan. 15, 2013.

(51) Int. Cl. A61H 15/02

(52) U.S. Cl. CPC A61H 15/02
USPC 601/19

(57) ABSTRACT

A heated roller for therapy that allows a user to easily, safely and conveniently combine the benefits of heat with the use of a roller. The heated roller includes a roller body having a substantially cylindrical exterior shape, an insulating material, perforations, and a hollowed core with an opening configured to receive a structural support. The structural support includes a hollowed core with an opening configured to receive a heating element. The heating element may be electric or non-electric and the heating element and the structural support may be formed into a single structure. The heated roller includes an openable cap to provide access to the internally positioned structural support and heating element.

### FIELD OF THE INVENTION

The present invention is directed generally to physical therapeutic equipment, and more specifically, to a heated roller.

### DESCRIPTION OF THE RELATED ART

Rollers are used in physical therapy and exercise and are sold in a variety of lengths, diameters, densities, and colors. Rollers are used in hospitals, physical therapy clinics, exercise classes, and at home. They are used for exercise, stretching, massage, posture, and balance.

### BRIEF DESCRIPTION OF THE SEVERAL VIEWS OF THE DRAWINGS

FIG. 1 is an illustration of an assembled heated roller.

FIG. 2 is an illustration of the heated roller of FIG. 1 when disassembled.

FIG. 3 is an illustration of the heated roller when partially assembled.

FIG. 4 is an illustration of the heated roller in use.

### DETAILED DESCRIPTION OF THE INVENTION

Heat may be used in physical therapy and exercise to confer physiological benefits and increase a user's comfort, such as when using a roller. However, the use of heat may be inefficient, impractical, or may pose a safety risk due to a potential risk of burning the user's skin. Roller users therefore have had difficulty combining the use of a roller with the use of heat.

For example, to combine the physiological benefits and increased comfort from the use of heat with the use of rollers, a user may preheat the targeted area of skin before using the roller. This form of treatment is inefficient because the user's skin may cool before the user finishes using the roller. Alternatively, a user may use the roller in a heated environment, but this form of treatment is impractical because of the difficulty in effectively, safely, and comfortably heating a room to a temperature that will heat the user's skin (e.g., up to 113 degrees F.). The user may also wrap the exterior of the roller with a heating element, but this may be dangerous because of the risk of burning the user's skin due to direct contact with the heating element.

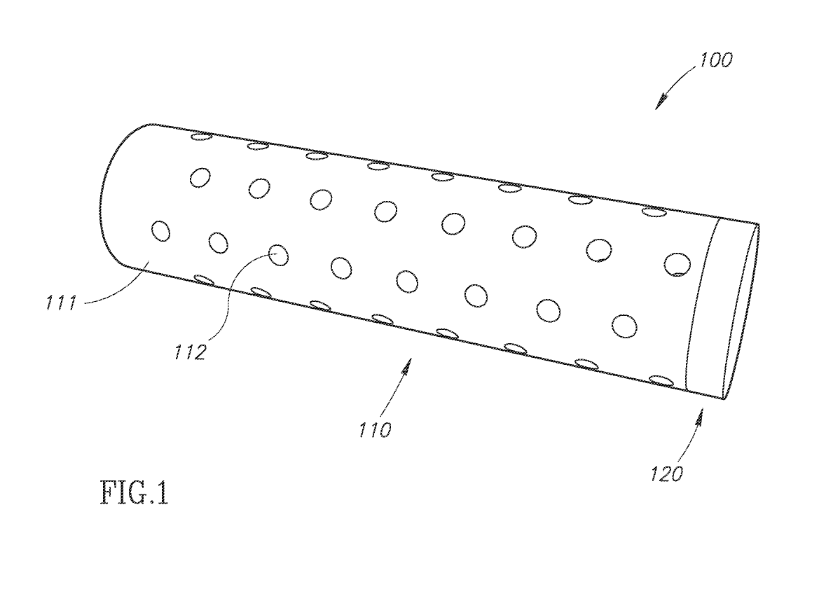

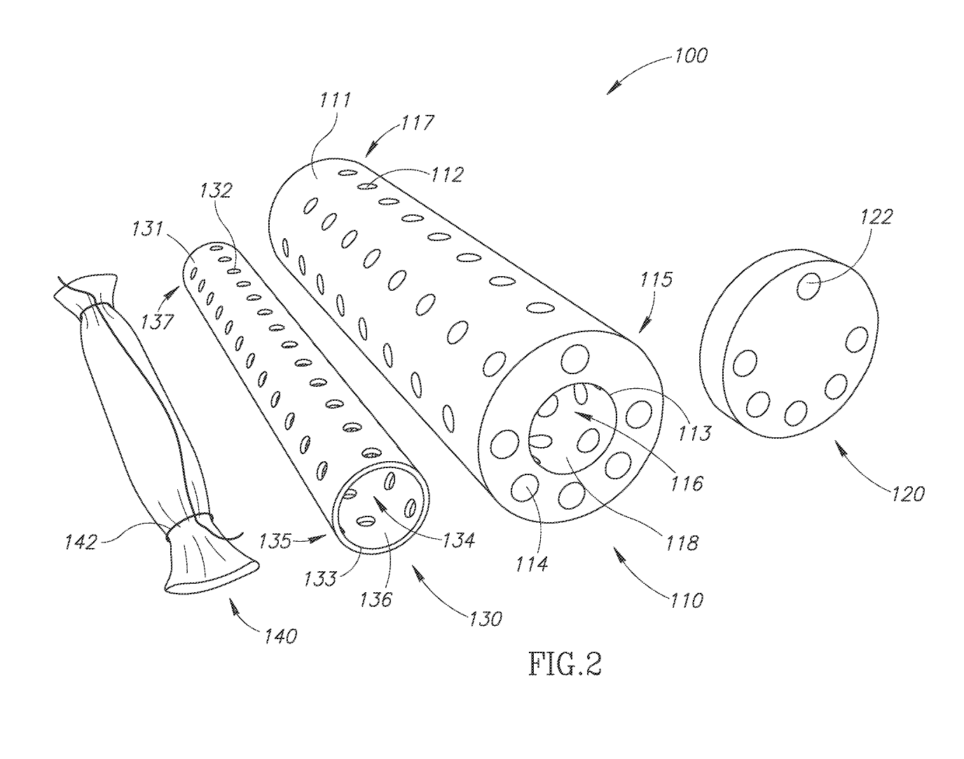

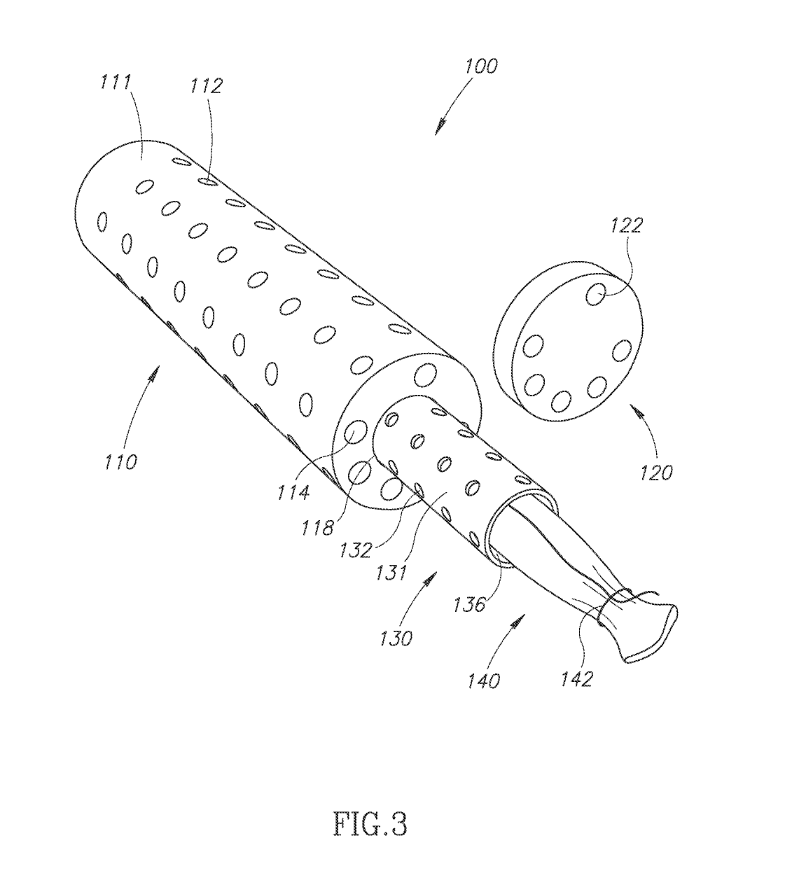

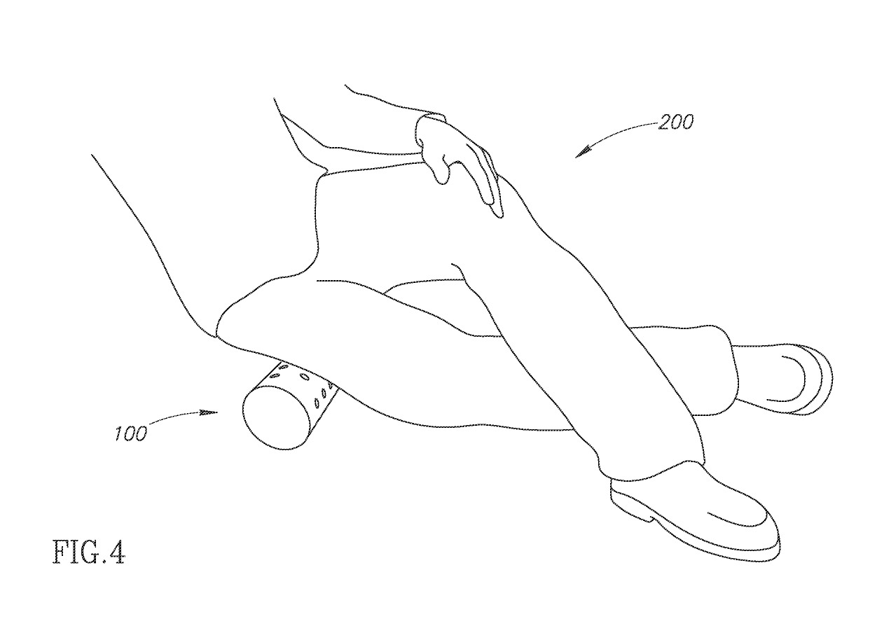

FIG. 1 illustrates an exemplary heated roller 100. The heated roller may include a roller body 110, a cap 120, a roller body exterior surface 111, and roller body perforations 112. This figure illustrates the heated roller 100 when it is fully assembled and ready for use by a user. Although not visible when assembled, the heated roller 100 may include numerous internal features. FIG. 2 illustrates the heated roller 100 when it has been disassembled. In addition to the roller body 110 and the cap 120, this figure also illustrates a structural support 130 and a heating element 140. The heating element 140 may be inserted into a hollowed structural support core 134 of the structural support 130 through an opening 136 in a first end 135 of the structural support 130. The structural support 130 may be inserted into a hollowed body core 116 of the roller body 110 through an opening 118 in a first end 115 of the roller body 110. FIG. 3 illustrates the heated roller 100 in a partially assembled form. Here, the heating element 140 is shown partially inserted into the structure support 130 through the opening 136 in the first end 135 of the structural support 130, which is in turn partially inserted into the body 110 through the opening 118 in the first end 115 of the roller body 110. The cap 120 remains unattached from the roller body 110. A user may place the cap 120 on the roller body 110 when assembly is completed by, for example, fully inserting the heating element 140 into the structural support 130, and fully inserting that combination into the roller body 110. FIG. 4 illustrates the heated roller 100 in use by a user 200. Here the user 200 is positioned on his side, placing his weight on the heated roller 100 under the upper portion of his leg.

### Body

The roller body 110 of the heated roller 100 forms the structure that comes into contact with the user 200. For some uses of the heated roller 100, the user 200 may lie on top of the heated roller 100 and shift his or her weight so that the heated roller 100 rolls under the body of the user 200. The weight of the user 200 compresses the tissues of the user 200 (particularly, the muscles of the user 200) against the roller body 110 of the heated roller 100 and the pressure the roller body 110 exerts on the user 200 results in a tissue massage. If the roller body 110 of the heated roller 100 is too firm, use of the heated roller 100 may be uncomfortable, or potentially even painful. On the other hand, if the roller body 110 of the heated roller 100 is too soft, the heated roller 100 may not provide enough resistance to compress the tissues of the user 200 sufficiently to confer any benefit during use. Thus, the roller body 110 may be formed from any number of materials that are not too hard or too soft. FIG. 2 illustrates a heated roller 100 with a roller body 110 formed in foam. However, the roller body 110 may also be formed in any other number of materials, including plastic, rubber, and cork. The density of the material comprising the roller body 110 of the heated roller 100 may vary according to any number of factors. Examples of factors important for determining the density include: the comfort level desired by the user 200, the weight of the user 200, and the intended type of use.

The roller body 110 of the heated roller 100 may be formed of a material of any number of colors. The color of the material forming the roller body 110 of the heated roller 100 may indicate information about the roller 100. For example, white may indicate a less dense material, black may indicate a more dense material, and red and blue may indicate an intermediate level of material density. Likewise, the color may indicate the intensity of the heat offered or the diameter of the heated roller 100. The exterior surface 111 of the roller body 110 may also be covered with colors or patterns for visual appeal or may include raised bumps or patterns for increased skin stimulation or tissue massage.

The roller body 110 of the heated roller 100 should be formed into a shape that allows the heated roller 100 to roll under the user 200 in a smooth and continuous motion when the user 200 shifts his or her weight over the heated roller 100; e.g. a shape that allows for rolling. Thus, the roller body 110 of the heated roller 100 may be formed in any number of shapes that include a round cross-section. For example, FIG. 2 illustrates a heated roller 100 with a cylinder shaped roller body 110, which has a circular cross-section.

The roller body 110 of the heated roller 100 may also have a wide variety of lengths and diameters. The roller body 110 should be long enough to be practical for use but short enough to facilitate convenient storage and transportation. For example, if the heated roller 100 is longer than the user 200, it may be difficult to maneuver for use or to transport. Conversely, if the heated roller 100 is too short, it may be difficult to use. In preferred embodiments, the roller body 110 may be between 15 centimeters and 183 centimeters (six inches and six feet) in length. FIG. 2 illustrates a heated roller 100 having a roller body 110 with an approximate length of 30 centimeters (one foot).

Likewise, the roller body 110 of the heated roller 100 should be wide enough to be practical for use, yet narrow enough to facilitate safe use. For example, if the diameter of the roller body 110 is too large, the heated roller 100 may not apply targeted pressure on the tissue of a user 200 and the user 200 may have difficulty balancing on the heated roller 100. Similarly, if the diameter of the roller body 110 is too small, it may not have space to house internal components. Thus, in preferred embodiments, the roller body 110 may be between five centimeters and 61 centimeters (two inches and two feet) in diameter. FIG. 2 illustrates a heated roller 100 with a roller body 110 with a diameter of approximately 18 centimeters (seven inches).

The roller body 110 of the heated roller 100 may include body attachment elements 114 that enable the roller body 110 to be attached to a removable cap 120. Attaching the cap 120 to the roller body 110 may reduce wasted heat loss from openings 118 in the ends 115 and 117 of the roller body 110, may improve the structural integrity of the heated roller 100 during use, and may reduce the likelihood that internal parts will unintentionally come out. Thus, the body attachment elements 114 may be configured to provide a secure attachment so that the cap 120 does not come off during use, but may also be configured to allow for convenient removal of the cap 120 to facilitate disassembly of the heated roller 100 for reheating the heating element 140 or cleaning, repairing, or replacing the heated roller 100 parts.

The body attachment elements 114 may be configured so as not to (or minimally) interfere with the ability of the heated roller 100 to roll. Likewise, the body attachment elements 114 may be positioned on the internal surfaces of the roller body 110 so as not to cause discomfort to the user 200. FIG. 2 illustrates a heated roller 100 with magnet-type body attachment elements 114, secured into recesses in the first end 115 of the roller body 110. During assembly, corresponding magnet-type cap attachment elements 122 secured into recesses in the cap 120 may be attached to the magnet-type body attachment elements 114. The magnet-type attachment elements 114 and 122 may be secured into recesses in the ends 115 and 117 of the roller body 110 and the cap 120 by an adhesive such as glue. But the attachment elements 114 and 122 may take many different forms. For example, attachment elements 114 and 122 may be formed by snaps, hook and loop fasteners, or screws. Alternatively, the attachment elements 114 and 122 may take the form of alterations to the shape of the ends 115 and 117 of the roller body 110 (such as groves) and cap 120 (such as threads) that allow the cap 120 to simply screw onto the ends 115 and 117 of the roller body 110.

### Heating Element

The heating element 140 provides heat that transfers through the structural support 130 and the roller body 110 to reach skin of the user 200. The heating element 140 may provide heat evenly along the length and diameter of the heated roller 100. The heating element 140 may be sized to fit into a hollowed core 134 of the structural support 130 through an opening 136 in the structural support 130. However, if the heating element 140 itself provides structural support, the heating element 140 and the structural support 130 may be formed integrally into the same component and the heating element 140 should fit into a hollowed body core 116 of the roller body 110 through an opening 118 in the roller body 110.

The heating element 140 may be an electric or non-electric heating element. If the heating element 140 is a non-electric heating element, it may be formed from microwaveable heating packs, boiling heating packs, chemical (instant) heating packs, hydrocollator pads, clay packs, hot stones, and ceramic elements. FIG. 2 illustrates the heated roller 100 with a microwaveable heating pack-type heating element 140. If the heating element 140 is an electric heating element, it may be formed from plug-in electric heating elements (such as a silicon electric heating pad) or battery powered heating elements.

For physiological benefits, the heated roller 100 may heat the skin of a user 200 to between approximately 104 and 113 degrees F. Skin heating above 113 degrees F. may pose a risk of burns. To heat the skin of a user 200 to this temperature range, the heating element 140 may reach a higher temperature, as some heat may be lost while traveling from the heating element 140 through the structural support 130 and roller body 110 of the heated roller 100 to the skin of the user 200.

The heating element 140 may be removable for reheating, cleaning, repair, or replacement. To increase the ease of removal or re-insertion, the heating element 140 may include a heating element harness 142 or a heating element handle (not shown). The heating element harness 142 may be formed from any number of materials, such as string, rope, or plastic tabs. For example, in FIG. 2 the heating element 140 has a string-type heating element harness 142.

Multiple heating elements 140 may be used to improve heating for a long or wide heated roller 100. For example, for a long heated roller 100, multiple heating elements 140 may be used end-to-end to improve heating over the length of the roller body 110 of the heated roller 100. Likewise, for a wide heated roller 100, multiple heating elements 140 may be used side-to-side to improve heating for the width of the roller body 110 of the heated roller 100.

### Perforations

The roller body 110 of the heated roller 100 may include body perforations 112 that extend between the exterior surface 111 and the interior surface 113 to improve heat transfer from the heating element 140 at the core of the heated roller 100 to the user's 200 skin. Perforations 112 may be particularly beneficial if the roller body 110 is formed from a thermally insulating material, such as foam. In some embodiment, body perforations 112 should not be too large or too numerous that they significantly compromise the structural integrity of the heated roller 100, but should not be too small or too few that heat does not effectively transfer from the heating element 140 at the core of the heated roller 100 to the skin of the user 200. For example, a heated roller 100 may have body perforations 112 with a diameter of one-third centimeter (one-eighth inch), two-third centimeter (one-quarter inch), one and one-quarter centimeters (one-half inch), two centimeters (three-quarter inch), or two and one-half centimeters (one inch) and may have between 20 to 500 body perforations 112. FIG. 2 illustrates a heated roller 100 with approximately 75 body perforations, each with an approximate diameter of two centimeters (three-quarter inch).

The number and size of body perforations 112 may depend on a number of factors such as: the dimensions of the roller body 110, including the roller body 110 thickness and diameter, the desired level of skin heating, the amount of heat produced by the heating element 140, the heat conducting properties of the roller body 110, the heat conducting properties of the structural support 130, the weight of the user 200, and the intended type of use. Further, the size of body perforations 112 may be decreased when more are used or increased when less are used. When different roller body 110 materials are used, different arrangements of perforations 112 may be utilized.

In addition to variations in size and number, the body perforations 112 may be formed of any number of shapes. The shape of the body perforations 112 may depend upon the same factors discussed above for the size and number of body perforations 112, or they may be selected for their aesthetic appeal. FIG. 2 illustrates a heated roller 100 with body perforations 112 formed in the shape of punch holes. Other shapes for body perforations 112 may include slits and pin holes.

Additionally, the body perforations 112 may be formed into any number of patterns. The pattern of body perforations 112 may aim to avoid transferring heat to areas the roller body 110 of the heated roller 100 that do not come into contact with the skin of the user 200, such as the ends 115 and 117 of the roller body 110. The pattern of body perforations 112 may also aim to improve even heat distribution across the skin of the user 200. Thus, a pattern with regularly spaced body perforations 112 that avoids the ends 115 and 117 of the roller body 110 may be used. Alternatively, a pattern may be selected that allows for approximately even heating but offers other aesthetic benefits, such as a spiral pattern.

### Hollowed Body Core

The roller body 110 of the heated roller 100 may be hollowed to form a hollowed body core 116 that houses the heating element 140. If the heating element 140 does not also provide structural support, the hollowed body core 116 may additionally house a structural support 130. If the heated roller 100 includes caps 120 on both ends 115 and 117 of the roller body 110, the hollowed body core 116 may extend through both ends 115 and 117 of the roller body 110, forming openings 118 at the first end 115 and at the second end 117 of the roller body 110. However, if the heated roller 100 includes a cap 120 on one end 115 of the roller body 110, the hollowed body core 116 may extend through the length of one end 115 of the roller body 110, forming an opening 118 at the first end 115 of the roller body 110.

The hollowed body core 116 may be formed into a shape that allows for easy insertion and removal of the structural support 130 and heating element 140. FIG. 2 illustrates a heated roller 100 with a hollowed body core 116 formed in the shape of a cylinder with a circular cross section. While the hollowed body core 116 may be formed into any shape, a shape with a circular cross section may improve the structural strength of the heated roller 100 and improve even heating.

The hollowed body core 116 and opening 118 may large enough to allow for easy insertion and removal of the heating element 140 or structural support 130. At the same time, the hollowed body core 116 may small enough so that the roller body 110 includes sufficient material to pad the user 200 against the hardened internal structural support 130. If the heated roller 100 has a cap 120 on one end 115 of the roller body 110, a hollowed body core 116 that is too long, may result in a thin layer of roller body 110 material on the uncapped end 117. During use, pressure on the heated roller 100 from the weight of the body of the user 200 may result in damage to the uncapped end 117 of the roller body 110 and the internal parts may come out. On the other hand, if the hollowed body core 116 is too short, it may be difficult to achieve even heating for the length of the heated roller 100.

Consequently, the dimensions of the hollowed body core 116 may depend on any number of factors, including: the dimensions of the roller body 110 of the heated roller 100, the dimensions of the heating element 140, the dimensions of the structural support 130, the desired level of skin heating, the amount of heat produced by the heating element 140, the heat conducting properties of the roller body 110, the heat conducting properties of the structural support 130, the user's 200 weight, and the intended type of use. FIG. 2 illustrates a heated roller 100 with an approximate diameter of 18 centimeters (seven inches) and a hollowed body core 116 with an approximate diameter of eight centimeters (three inches). Likewise, FIG. 2 illustrates a heated roller 100 with an approximate length of 30 centimeters (one foot) and a hollowed body core 116 with an approximate length of 28 centimeters (11 inches).

### Structural Support

The heated roller 100 may also include a structural support 130. The structural support 130 may be housed in the hollowed body core 116 of the roller body 110 and house the heating element 140. The structural support core 134 may extend through both ends 135 and 137 of the structural support 130, forming openings 136 at the first end 135 and a second end 137 of the structural support 130.

The structural support 130 may improve the integrity of the heated roller 100 to compensate for any loss in structural integrity resulting from the hollowed body core 116 and the body perforations 112. The structural support 130 may also protect the internally housed heating element 140.

The structural support 130 may be formed into the shape of the hollowed body core 116. The thickness of the walls of the structural support 130 may depend on the type of material used to form the structural support 130, the heat conducting properties of the structural support 130, the dimensions of the hollowed body core 116, the dimensions of the heating element 140, and the size and number of structural support perforations 132. The structural support 130 should be formed of a sturdy material that can withstand pressure from use. FIG. 2 illustrates a heated roller 100 with a structural support 130 formed from PVC, or polyvinyl chloride, of approximately one-third centimeter (one-eight inch) thickness. The material forming the structural support 130 may also have heat conducting properties that improve the transfer of heat from the heating element 140 to the skin of the user 200.

Additionally, if the structural support 130 is formed from a thermally insulating material, the structural support 130 may be perforated with structural support perforations 132 that extend between the exterior surface 131 and the interior surface 133 of the structural support 130 to improve heat transfer from the heating element 140 into the roller body 110. Structural support perforations 132 should not be too large or too numerous that they undermine the structural integrity of the structural support 130, but should not be too small or too few that heat does not effectively transfer from the heating element 140 at the core of the heated roller 100 to the skin of the user 200. For example, a heated roller 100 may have structural support perforations 132 with a diameter of one-third centimeter (one-eighth inch), two-third centimeter (one-quarter inch), one and one-quarter centimeter (one-half inch), two centimeters (three-quarter inch), or two and one-half centimeters (one inch) and may have between 20 to 500 structural support perforations 132. FIG. 2 illustrates a heated roller 100 with approximately 150 structural support perforations 132, each with an approximate diameter of one and one-quarter centimeter (one-half inch).

The number and size of structural support perforations 132 may depend on factors such as: the dimensions of the structural support 130, including the structural support 130 thickness, the desired level of skin heating, the amount of heat produced by the heating element 140, the heat conducting properties of the roller body 110, the heat conducting properties of the structural support 130, the user's 200 weight, and the intended type of use. Further, The size of the structural support perforations 132 may be decreased when more are used or increased when less are used.

In addition to variations in size and number, the structural perforations 132 may be formed of any number of shapes. The shape of the structural support perforations 132 may depend upon the same factors discussed above for the size and number of structural support perforations 132. FIG. 2 illustrates a heated roller 100 with structural support perforations 132 formed in the shape of punch holes. Other shapes for structural support perforations 132 may include slits and punch holes.

Additionally, the structural support perforations 132 may be formed into any number of patterns. The pattern of structural support perforations 132 may aim to avoid transferring heat to areas the roller body 110 of the heated roller 100 that do not come into contact with the skin of the user 200, such as the ends 115 and 117 of the roller body 110. The pattern of structural support perforations 132 may also aim to improve even heat distribution across the skin of the user 200. Thus, a pattern with regularly spaced perforations that avoids the ends 135 and 137 of the structural support 130 may be used.

Further, the structural support perforations 132 may be similar to or identical to the body perforations 112 in number, shape, size, and pattern. In an example embodiment, the structural support perforations 132 may also be aligned with body perforations 112. This arrangement may improve heat transfer from the heating element 140 through the structural support 130 and through the roller body 110 to the skin of the user 200.

The heated roller 100 may include a cap 120 located on one or both ends 115 and 117 of the roller body 110. A cap 120 located on both ends 115 and 117 of the roller body 110 of the heated roller 100 may allow for insertion and removal of multiple heating elements 140 into openings 118 in both ends 115 and 117 of a long roller body 110. The cap 120 may reduce heat loss from the ends 115 and 117 of the roller body 110, improve the structural integrity of the roller 100 during use, and reduce the likelihood that internal parts will unintentionally come out.

The cap 120 may be completely or partially removable and thus include cap attachment elements 122. The cap attachment elements 122 provide a secure attachment so that the cap 120 does not unintentionally come off during use, but also allows for convenient removal of the cap 120 to facilitate disassembly of the heated roller 100 for reheating the heating element 140 or cleaning, repairing, or replacing the heated roller 100 parts.

The cap attachment elements 122 may be configured so as not to interfere with the ability of the heated roller 100 to roll without causing discomfort to the user 200. FIG. 2 illustrates magnet-type cap attachment elements 122, secured into recesses in the cap 120. During assembly, corresponding magnet-type body attachment elements 114 secured into recesses in the ends 115 and 117 of the roller body 110 may be attached to the magnet-type cap attachment elements 122. The magnet-type attachment elements 114 and 122 may be secured into recesses in the ends 115 and 117 of the roller body 110 and cap 120 by an adhesive such as glue. In a similar manner to the body attachment elements 114, examples of cap attachment elements 122 include snaps, hook and loop fasteners, and screws.

### Accessories

The heated roller 100 may include accessories, such as a sleeve for covering the heated roller 100 and a device for heating the heating element 140. The sleeve may help keep the heated roller 100 clean, may improve ease of transporting the heated roller 100, and may improve heat retention in the heated roller 100 during breaks in use. Additionally, the sleeve may include a sleeve handle to further improve ease of transporting the heated roller 100.

A device for heating the heating element 140 may be used to heat the heating element 140 before use and for reheating the heating element 140 during breaks in use. For example, a hydrocollator or a stone heater may be used to heat heating elements 140 such as clay packs and hot stones.

### Use

There are many types of use for the heated roller 100. FIG. 4 illustrates a user 200 using the heated roller 100 to massage the hamstrings. The heated roller 100 may be used for physical therapy, exercise, stretching, massage, posture, and balance. Some, but not all embodiments of the heated roller 100 may offer physiological benefits. Likewise, some, but not all uses of the heated roller 100 may offer benefits of increased user 200 comfort. For example, for a user 200 may lie on his or her back with arms stretched out and a heated roller 100 under the back to form a fulcrum that results in a pectoral muscle stretch. In this case, the heat from the heated roller 100 may increase the comfort of the user 200, by supplying heat to the back of the user 200, even though heat may not be supplied to the pectoral muscles being stretched.

The invention claimed is:

1. A heated roller for therapy, the heated roller comprising:
a roller body having an exterior surface defining a substantially cylindrical exterior shape and an interior surface defining a roller body core having a hollowed shape, wherein the roller body comprises an insulating material, a first end having an opening therein and a second end opposite the first end, and perforations that extend between the exterior surface and the interior surface;
a structural support removably positionable inside the roller body core having an exterior surface sized to be positioned inside the roller body core and an interior surface defining a structural support core having a hollowed shape, wherein the structural support comprises a first end having an opening therein and a second end opposite the first end; and
a heating element removably positionable inside the structural support core having an exterior surface sized to allow the heating element to be positioned inside the structural support core.

2. The heated roller of claim 1, wherein the insulating material is selected from the group consisting of foam, plastic, rubber, and cork.

3. The heated roller of claim 1, wherein the heating element comprises an electric heating element.

4. The heated roller of claim 1, wherein the roller body further comprises:
a cap selectively couplable to the first end and configured to cover the opening; and
a body attachment element coupled to the roller body;
a cap attachment element coupled to the cap;
wherein the body attachment element and the cap attachment element are configured to selectively couple together such that the cap covers the opening.

5. The heated roller of claim 1, wherein the structural support further comprises perforations that extend between the exterior surface and the interior surface of the structural support to facilitate heat transfer from the heating element positioned inside the structural support core to the exterior surface of the heated roller.

6. The heated roller of claim 1, wherein the exterior shape of the roller body has a length between 15 centimeters and 183 centimeters (six inches and six feet) and a diameter between five centimeters and 61 centimeters (two inches and two feet).

7. The heated roller of claim 1, wherein the heating element comprises a non-electric heating element.

8. The heated roller of claim 7, wherein the non-electric heating element is selected from the group consisting of microwaveable heating packs, boiling heating packs, chemical heating packs, hydrocollator pads, clay packs, hot stones, and ceramic elements.

9. The heated roller of claim 8, wherein the heating element further comprises a heating element harness configured to facilitate insertion and removal of the heating element with respect to the structural support core.

10. A heated roller for therapy, the heated roller comprising:
a roller body having an exterior surface defining a substantially cylindrical exterior shape and an interior surface defining a roller body core having a hollowed shape, wherein the roller body comprises an insulating material, two ends and an opening in at least one end, and perforations that extend between the exterior surface and the interior surface; and
a heating element removably positionable inside the roller body core having an exterior surface sized to allow the heating element to be positioned inside the roller body core.

11. The heated roller of claim 10, wherein the roller body further comprises:
a cap selectively couplable to the first end and configured to cover the opening; and
a body attachment element coupled to the roller body;
a cap attachment element coupled to the cap;
wherein the body attachment element and the cap attachment element are configured to selectively couple together such that the cap covers the opening.

12. The heated roller of claim 11, wherein the body attachment element and the cap attachment element are selected from the group consisting of magnets, snaps, hook and loop fasteners, screws, and grooves and threads.

13. The heated roller of claim 12, wherein the body attachment element comprises a first magnet coupled thereto and the cap attachment element comprises a second magnet coupled thereto, the first and second magnets being positioned adjacent to each other when the cap is positioned to cover the opening such that the first and second magnets attract to each other and secure the cap in the position such that the cap covers the opening.

14. The heated roller of claim 10, further comprising a structural support removably positionable inside the roller body core having an exterior surface sized to be positioned inside the roller body core and an interior surface defining a structural support core having a hollowed shape, wherein the structural support comprises two ends and an opening in at least one end, and the structural support is configured to removably receive the heating element therein.

15. The heated roller of claim 10, wherein the heating element comprises a ceramic material capable of retaining heat and configured to provide structural support for the roller body.

16. A heated therapy system for use with a heating element, the heated therapy system comprising:
a roller body having an exterior surface defining a substantially cylindrical exterior shape and an interior surface defining a roller body core having a hollowed shape, wherein the roller body comprises an insulating material, two ends and at least one opening in at least one end, and perforations that extend between the exterior surface and the interior surface; and
a structural support removably positionable inside the roller body core having an exterior surface sized to be positioned inside the roller body core and an interior surface defining a structural support core having a hollowed shape, wherein the structural support comprises two ends and an opening in at least one end that provides access to the structural support core, wherein the structural support core is configured to removably receive a heating element therein through the opening of the structural support.

17. The heated therapy system of claim 16, wherein the insulating material is selected from the group consisting of foam, plastic, rubber, and cork.

18. The heated therapy system of claim 16, wherein the roller body further comprises a cap couplable to the end and configured to cover the opening, and at least one body attachment element coupled to the roller body and at least one cap attachment element coupled to the cap, the body attachment element and the cap attachment element together being configured to secure the cap in a position such that the cap covers the opening.

19. The heated therapy system of claim 16, wherein the structural support further comprises a material having a hardness greater than a hardness of the roller body, and is configured to protect the internally positioned heating element and provide support to the externally disposed roller body.

20. The heated therapy system of claim 16, wherein the structural support further comprises perforations that extend between the exterior surface and the interior surface to facilitate heat transfer from the internally positioned heating element to the exterior surface of the roller body.
